(19) United States
(12) Patent Application Publication
(10) Pub. No.: US 2007/0296933 A1
(43) Pub. Date: Dec. 27, 2007

(54) Image Forming Apparatus and Control Method Thereof

(75) Inventors: Toshiyuki WATANABE, Kanagawa-ken (JP); Ikuo Nishida, Kanagawa-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/423,392

(22) Filed: Jun. 9, 2006

(51) Int. Cl. G03B 27/00

(52) U.S. Cl. 355/18

(57) ABSTRACT

An image forming apparatus includes a main body of the image forming apparatus and an enabler connectable to the main body. Identification information of a user and parameter information concerning an arbitrary function among plural functions which the image forming apparatus can process, are stored in the enabler. When the enabler is set in the main body of the image forming apparatus, authentication check of the identification information is performed. When the identification information is authenticated, use of any one or all of the plural functions is permitted. The parameter information is read out from the enabler and a function corresponding to the parameter information among the functions permitted is carried out according to the parameter information.

### BACKGROUND OF THE INVENTION

1. Field of the Invention

The present invention relates to image forming apparatuses such as an MFP (Multi-Function Peripherals) which is digital complex machine, a copying machine, and a printer and a control method of the image forming apparatuses and realizes improvement of security.

2. Description of the Related Art

In general, some image forming apparatuses such as an MFP, a copying machine, and a printer have plural functions such as a copy function and a scan function. In such image forming apparatuses of a compound type, when plural same image data are copied or scanned, the image data are temporarily stored in a storage device such as an HDD and the image data are read out from this storage device and outputted by a printer unit. It is also possible to connect an MFP and a PC (personal computer) via a network to print image data created by the PC with the MFP or transmit image data scanned and read by the MFP to the PC.

In the image forming apparatuses, since image data remain in the storage device such as the HDD, there is a problem in terms of security protection of the image data Therefore, security is improved by limiting the functions of the image forming apparatuses or limiting users of the image forming apparatuses.

In an image forming apparatus described in JP-A-2005-33277, as an example, a USB interface is provided in an MFP, and plural enablers can be selectively connected to this interface. Each of the enablers includes a memory. Option programs for a printer function, a scanner function, and the like are stored in the memory. By connecting the enabler to the MPF, it is possible to use the printer function and the scan function provided in the MFP.

In an image forming apparatus described in JP-A-2004-303222, as an example, a slot through which a recording medium (e.g., an SD card) can be inserted into a main body of the image forming apparatus is provided and a program for image formation is stored in this SD card. When the SD card is inserted in the slot, the image forming apparatus performs authentication check of the SD card and, if a result of the authentication check is normal, reads out the program for image formation from the SD card and starts the program.

However, although security is improved by limiting the functions of the image forming apparatuses or limiting users through the authentication check, there remains a problem in that operation is complicated. For example, in the image forming apparatuses, when copying or printing is performed, image data is temporarily stored in the storage device (e.g., the HDD). However, the image data remains in the HDD. Therefore, when it is desired to erase the image data remaining in the HDD, the image data is erased by overwrite processing. However, operation and the like for setting the number of times of overwrite are required. Therefore, operation is complicated.

The present invention provides an image forming apparatus that realizes improvement of security and improvement of operability and a control method of the image forming apparatus.

### BRIEF DESCRIPTION OF THE DRAWINGS

FIG. 1 is a diagram for explaining an external appearance of an image forming apparatus of the invention;

FIG. 2 is a block diagram for explaining a structure of the image forming apparatus of the invention; and

FIG. 3 is a flowchart for explaining operations of the image forming apparatus of the invention.

### DETAILED DESCRIPTION OF THE INVENTION

Throughout this description, the embodiment and example shown should be considered exemplars, rather than limitations on the apparatus and methods of the invention.

An embodiment of the invention will be hereinafter explained in detail with reference to the drawings. In the respective figures, identical components are denoted by identical reference numerals and signs.

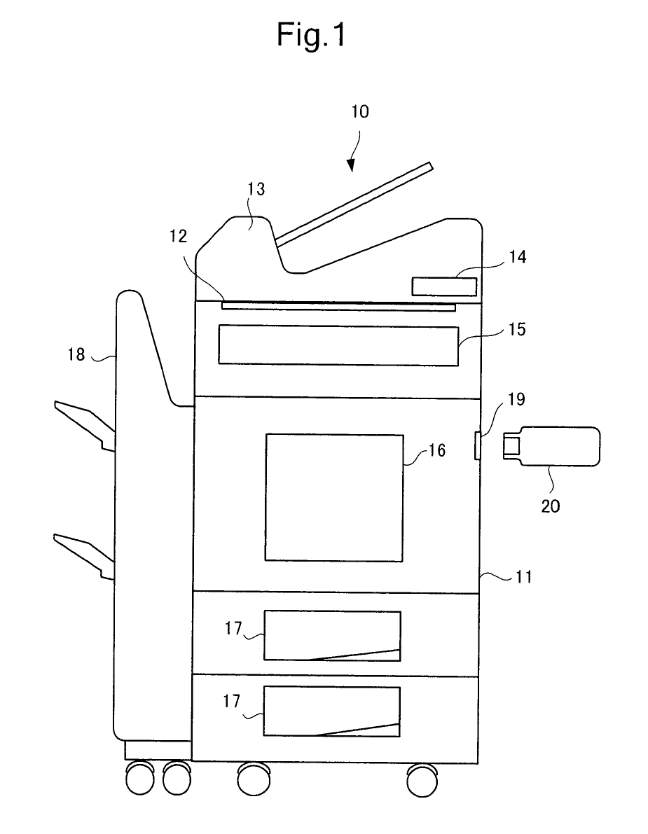

FIG. 1 is a diagram showing an external appearance of an embodiment of an image forming apparatus of the invention. In the following explanation, an MFP (Multi-Function Peripherals), which is a complex machine, will be explained as an example. However, it is also possible to apply the invention to a printer, a copying machine, and other image forming apparatuses.

In FIG. 1, reference numeral 10 denotes an image forming apparatus. A document table 12 is provided in an upper portion of a main body 11 of the image forming apparatus. An automatic document feeder (ADF) 13 is provided on the document table 12 to be freely opened and closed. An operation panel 14 is provided in an upper portion of the main body 11. The operation panel 14 has an operation unit 141 consisting of various keys for setting operation conditions and a display unit 142. The operation unit 141 includes a start key, a ten key, a copy key, a scan key, a print key, a facsimile key, and a setting/registration key.

The image forming apparatus 10 has a scanner 15 and a printer 16 in the main body 11. Plural cassettes 17 having stored therein sheets of various sizes are provided in a lower portion of the main body 1. Printed sheets are discharged from a side of the main body 1. A finisher 18 that applies post processing such as stapling to the sheets discharged is provided as required.

A USB port 19 for setting an enabler 20 is provided on another side of the main body 1 (USB is the abbreviation of Universal Serial Bus) The enabler 20 is a device for specifying a user who can use the image forming apparatus 10. When the enabler 20 is connected to the USB port 19, the image forming apparatus 10 comes into an available state.

The enabler 20 includes a ROM 201. Besides identification information of a user who uses the image forming apparatus 10, parameter information and reference information are stored in the ROM 201.

As the identification information, information such as a user name, a user ID, a password, and a department to which the user belongs is stored. The parameter information is information for causing the image forming apparatus 10 to carry out functions, which are processed by the image forming apparatus 10, under conditions set in advance. The parameter information may also be referred to as software setting information. Therefore, when the enabler 20 is connected to the USB port 19, the image forming apparatus 10 can carry out various functions on the basis of the parameter information stored.

Examples of the functions to be processed by the image forming apparatus 10 include a printer function, a scan function, a color copy function, a network print function, and a fax function.

The printer function is a function for printing image data. The scan function includes a file function for coping image data read by the scanner 15 and storing image data scanned by the main body 11 in a PC (personal computer) or the like described later and a mail function for transmitting the image data scanned by the main body 11 to external apparatuses in a form of an e-mail. The network print function is a function for printing, on the main body 11 side, image data sent from the external apparatuses to the main body 11. The fax function is a function for transmitting image data by fax. As other functions, there is an overwrite function in erasing image data stored in the HDD.

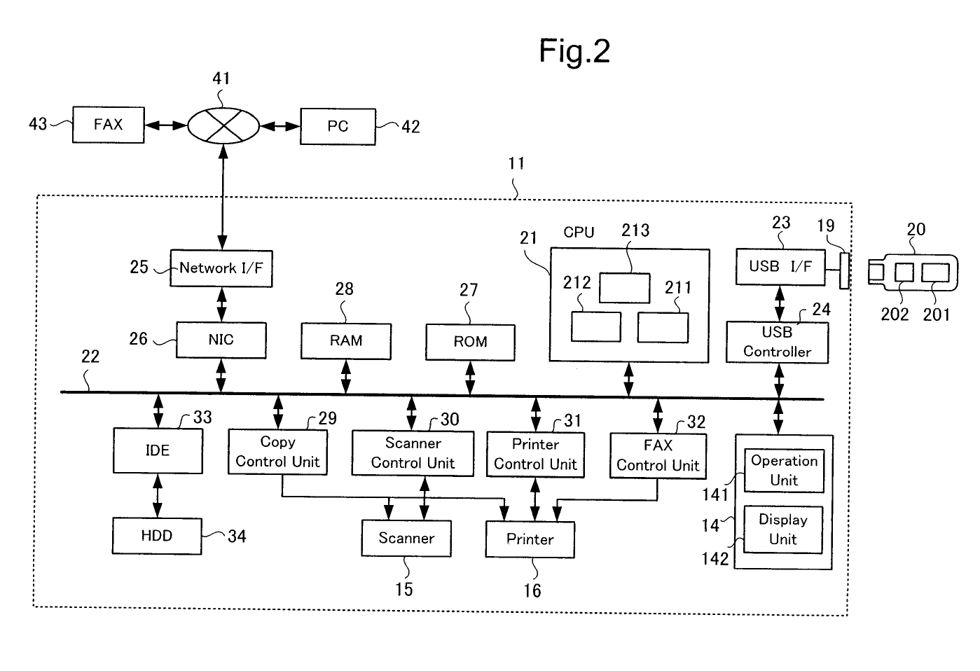

FIG. 2 is a block diagram showing a structure in the main body 11 of the image forming apparatus. The enabler 20 has the ROM 201. As described above, the identification information for authentication, the parameter information, and the reference information are stored in the ROM 201. The enabler 20 includes a USB interface 202 that transmits data in the ROM 201 to the USB port 19.

On the other hand, a CPU 21 is provided in the main body 11. The CPU 21 includes a control unit 211, a registering unit 212, and an authenticating unit 213 and is connected to a PCI bus 22. The PCI bus is the abbreviation of Peripheral Component Interconnect Bus. A USB interface 23 and a network interface 25 are further provided in the main body 11. The USB interface 23 is connected to the PCI bus 22 via a USB controller 24. The network interface 25 is connected to the PCI bus 22 via an NIC (Network Interface Card) 26.

The enabler 20 is connectable to the main body 11 via the USB interface 23. When the enabler 20 is connected to the main body 11, the USB controller 24 reads information from the enabler 20 and supplies the information read to the CPU 21. The network interface 25 includes a LAN board, a FAX modem, and the like and is connected to external apparatuses, for example, a PC 42 and a facsimile apparatus 43, via an external communication line 41. The NIC 26 controls data transmission and reception between the image forming apparatus 10 and the external apparatuses via the network interface 25.

A ROM 27, a RAM 28, a copy control unit 29, a scanner control unit 30, a printer control unit 31, a FAX control unit 32, and an operation panel 14 are connected to the PCI bus 22. Moreover, an HDD (hard disk device) 34 is connected to the PCI bus 22 via an IDE 33. The IDE 33 is an interface for connecting the HDD 34 to the PCI bus 22. IDE is the abbreviation of Integrated Device Electronics.

Various control programs necessary for operations of the main body 11 are stored in the ROM 27. The RAM 28 stores various data. The copy control unit 29 controls a usual copy function that uses the scanner 15 and the printer 16. The scanner control unit 30 controls a scan function that uses the scanner 15, a file function for storing scanned image data in the PC 42, and a mail function for transmitting image data to external apparatuses. The printer control unit 31 controls a print function or a network print function that uses the printer 16. The FAX control unit 32 controls a facsimile function. Image data to be subjected to print processing by the printer 16 is stored in the HDD 34. After the print processing, the image data is erased from the HDD 34 by overwrite processing.

The CPU 21 includes the control unit 211, the registering unit 212, and the authenticating unit 213. The registering unit 212 registers identification information of users in the RAM 28 and registers information indicating permission or prohibition of use for each function in the RAM 28 in order to specify an available function among the functions provided in the main body 11 when the enabler 20 is implemented. Alternatively, all the functions are registered. For execution of such registration processing, a user operates the operation unit 141 of the operation panel 14 and inputs functions while looking at the display unit 142.

The authenticating unit 213 performs authentication check on the basis of the identification information when the enabler 20 is implemented in the USB port 19. The control unit 211 controls permission or prohibition of use of the functions registered in the registering unit 212. When the enabler 20 is implemented, the control unit 211 permits use of a predetermined function on the basis of an authentication result. In the case of prohibition, the control unit 211 displays an indication to that effect on the display unit 142.

Among the plural functions, there is the function of overwrite processing for erasing the image data stored in the HDD 34. The information representing the number of times of overwrite is stored in the enabler 20 as the parameter information. In the overwrite processing, overwrite is performed on the basis of the number of times information stored.

It is also possible to store the reference information in the enabler 20. For example, when the image forming apparatus 10 has a network function, address book information, communication log information, accounting information at the time when the image forming apparatus 10 is used, or the like of a user is stored. It is possible to use the address book information in transmitting scanned image data by email. The communication log information is communication record of transmission and reception. The accounting information is information allocated for each user on the basis of the log information.

Operations of the image forming apparatus of the invention will be explained. A setting/registration key is provided on the operation panel 141. When the setting/registration key is operated by an administrator, a screen for registering a user is displayed on the display unit 142 and the image forming apparatus 10 comes into a registration mode.

When the registration mode is set, the administrator designates a user name, a user ID, and the like to register a user who can use the image forming apparatus 10. When the user registration is completed, the mode is switched to a function registration mode. The administrator registers available functions such as the print function, the scan function, the color copy function, the network print function, and the facsimile function. In making all the functions available, the registration process may be omitted. In registering the functions, codes representing any one or all of the functions are stored.

In other words, among the functions provided in the image forming apparatus 10, functions permitted to be used and functions prohibited from being used are specified. Execution of the overwrite processing on the HDD 34 after the print processing is registered. In this way, the registration of permission and prohibition concerning the enabler 20 is completed.

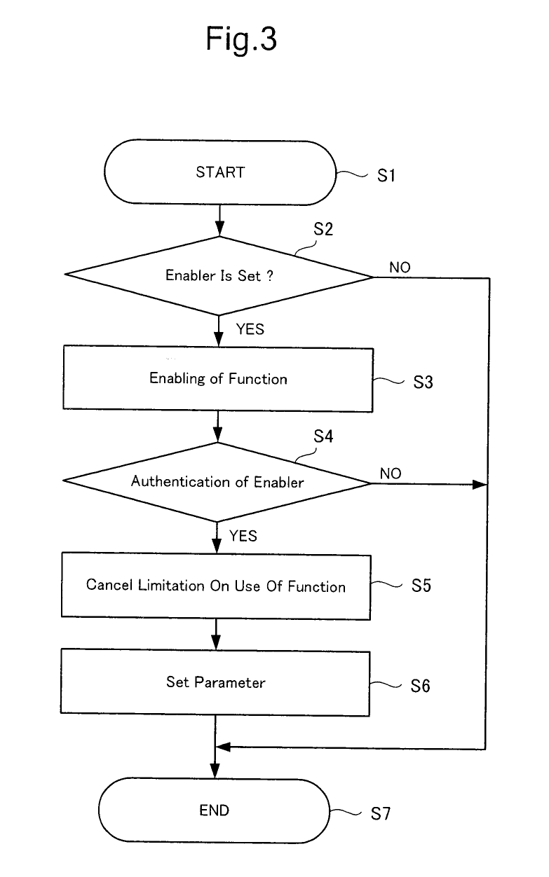

FIG. 3 shows a flowchart after the enabler 20 is set in the USB port 19. Authentication processing is started in step S1.

Step S2 is a step of judging whether the enabler 20 is set in the USB port 19. When it is judged that the enabler 20 is set, the CPU 21 proceeds to the next step S3. When the enabler 20 is not set, the CPU 21 proceeds to end step S7. When it is judged that the enabler 20 is set, in step S3, processing for enabling the various functions of the image forming apparatus 10 registered earlier is performed to bring the image forming apparatus 10 into a state in which the registered functions are available.

Step S4 is a step of performing individual authentication for the enabler 20. The CPU 21 reads out the identification information (a user name, a user ID, etc.) stored in the enabler 20 and judges whether a user is registered in advance. When a password is recorded, the CPU 21 also reads data of the password and performs user authentication. When the user is not authenticated in step S4, the CPU 21 shifts to step S7 and ends the processing.

When the user is authenticated in step S4, in step S5, the CPU 21 cancels the limitation on use of the functions of image forming apparatus 10 to make it possible to use the registered functions. It is possible to use the various functions at this stage. When the parameter information is further stored in the enabler 20, processing is applied to functions corresponding to the parameter information in accordance with a parameter set in step S6.

For example, after the print processing ends, when the overwrite processing is performed in order to erase the image data stored in the HDD 34, if information of the number of times of overwrite “3” is stored as a parameter, the overwrite processing is automatically executed three times.

In this way, in the invention, it is possible to use a predetermined function of the image forming apparatus 10 by setting the enabler 20 and only a specific user can use the function because individual authentication is performed. Thus, it is possible to realize improvement of security. When the parameter information is stored in advance, the function is automatically carried out in accordance with the parameter.

Therefore, since a user can use a series of functions simply by setting the enabler 20 and can perform processing on the basis of a desired parameter, operability is improved. Since a user ID and a password used for individual authentication are read out from the enabler 20, the user does not need to input the user ID and the password. Thus, others never steel a glance at the user ID and the password.

In the explanation of the embodiment described above, available functions are registered in advance by the registering unit 212 of the CPU 21. However, available functions may be registered in the ROM 201 of the enabler 20. For example, if all the functions registered in the enabler 20 are available, it is possible to use all the functions by setting the enabler 20. When only the printer function and the scan function are registered, it is impossible to use other functions (e.g., the color copy function, the network print function, and the fax function).

In registering the available functions in the enabler 20, codes representing any one or all of the functions are stored in the ROM 201. When the enabler 20 is set, a function code registered in the enabler 20 is read out on the main body 11 side to enable only a function corresponding to the code. It is possible to use a specific function by combining a code with an authentication result of a user.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus having plural functions comprising:
an enabler that is connectable to a main body of the image forming apparatus and has a first storing unit, in which at least identification information of a user and parameter information concerning an arbitrary function among the plural functions are stored;
a port provided in the main body of the image forming apparatus and used for setting the enabler;
an authenticating unit configured to perform authentication check of the identification information when the enabler is set in the port;
a control unit configured to permit use of the plural functions when the user is authenticated by the authenticating unit; and
a parameter setting unit configured to read out the parameter information from the enabler, and carry out a function corresponding to the parameter information among the functions permitted according to the parameter information.

2. An image forming apparatus according to claim 1, wherein
one of the functions permitted to be used is a function for erasing image data stored in a storage device in the main body with overwrite processing, and
the parameter information is information indicating a number of times of overwrite.

3. An image forming apparatus according to claim 1, wherein the plural functions to be processed by the image forming apparatus include a print function and a scan function.

4. An image forming apparatus according to claim 1, wherein the plural functions to be processed by the image forming apparatus include, besides the print function and the scan function, a color copy function, a network print function, and a fax function.

5. An image forming apparatus according to claim 1, wherein the identification information stored in the enabler includes a user ID and a password.

6. An image forming apparatus according to claim 1, further comprising a display unit, wherein
when the user is not authenticated as a result of the authentication check by the authenticating unit, an indication that the user is not authenticated is displayed on the display unit.

7. An image forming apparatus according to claim 1, wherein reference information including address book information, communication log information, and accounting information of the user is stored in the first storing unit of the enabler.

8. An image forming apparatus according to claim 1, wherein the port is a USB port.

9. An image forming apparatus having plural functions comprising:
an enabler that is connectable to a main body of the image forming apparatus and having a first storing unit, in which at least identification information of a user and parameter information concerning an arbitrary function among the plural functions are stored;
a port provided in the main body of the image forming apparatus and used for setting the enabler;
a function registering unit configured to register functions available for the user among plural functions to be processed by the image forming apparatus;
an authenticating unit configured to perform authentication check of the identification information when the enabler is set in the port;
a control unit configured to permit use of the functions registered in the function registering unit when the user is authenticated by the authenticating unit; and
a parameter setting unit configured to read out the parameter information from the enabler, and carry out a function corresponding to the parameter information among the functions permitted according to the parameter information.

10. An image forming apparatus according to claim 9, wherein
the function registering unit having a second storing unit provided in the main body of the image forming apparatus and stores codes representing the functions available for the user in the second storing unit, and
the control unit reads out a code from the second storing unit in response to the setting of the enabler and judges a function registered.

11. An image forming apparatus according to claim 9, wherein
the function registering unit stores codes representing the functions available for the user in the first storing unit of the enabler, and
the control unit reads out a code from the first storing unit in response to the setting of the enabler and judges a registered function.

12. An image forming apparatus according to claim 9, wherein
one of the functions registered in the function registering unit is a function for erasing image data stored in a storage device in the main body with overwrite processing, and
the parameter information is information indicating a number of times of overwrite.

13. A control method of an image forming apparatus having plural functions, the image forming apparatus including an enabler connectable to a main body of the image forming apparatus and having a first storing unit, in which at least identification information of a user and parameter information concerning an arbitrary function among the plural functions are stored,
the control method comprising the steps of:
judging that the enabler is set in the main body;
reading out the identification information to perform authentication check when the enabler is set in the main body;
canceling limitation on use of the plural functions when the user is authenticated by the authentication check; and
reading out the parameter information from the enabler, and processing a function corresponding to the parameter information among the functions for which the limitation on use is cancelled according to the parameter information.

14. A control method of an image forming apparatus according to claim 13, wherein
one of the functions for which the limitation on use is canceled is a function for erasing image data stored in a storage device in the main body with overwrite processing, and
a number of times of overwrite is set on the basis of the parameter information.

15. A control method of an image forming apparatus according to claim 13, further comprising the steps of:
registering a function available for the user among the plural functions to be processed by the image forming apparatus, and
canceling limitation on use of the function registered when the user is authenticated by the authentication check.
